(19) United States
(12) Patent Application Publication
(10) Pub. No.: US 2015/0308393 A1
(43) Pub. Date: Oct. 29, 2015

(54) Separator Element of a Separator Device For Separating at Least One Fluid Medium From a Fluid to be Treated and Separator Device

(71) Applicant: MANN+HUMMEL GMBH, Ludwigsburg (DE)

(72) Inventors: Gernot Boiger, Winterthur (CH); Martin Veit, Gaertringen (DE); Jochen Reyinger, Waiblingen (DE)

(21) Appl. No.: 14/698,162

(22) Filed: Apr. 28, 2015

(30) Foreign Application Priority Data
Apr. 28, 2014 (DE) 10 2014 005 999.5

(51) Int. Cl. F02M 37/22; B01D 35/30; B01D 35/00; B01D 29/58

(52) U.S. Cl. CPC F02M 37/22; B01D 29/58; B01D 35/30; B01D 35/005

(57) ABSTRACT

A separator element (36) of a separator device, in particular of a filter (10), at least for separating at least one fluid medium to be separated, in particular water, from a fluid to be treated, in particular fuel, in particular diesel fuel, in particular of an internal combustion engine, in particular of a motor vehicle, and a separator device (10) are described. The separator element (36) has at least one coalescence medium (58) in the form of a hollow body for coalescing the at least one fluid medium to be separated. At least one pre-treatment medium (57) for pre-treating the fluid to be treated is arranged in the flow path (78) of the fluid to be treated before the at least one coalescence medium (58), encompassing said coalescence medium or in an interior space encompassed thereby.

### TECHNICAL FIELD

The invention relates to a separator element of a separator device, in particular of a filter, at least for separating at least one fluid medium to be separated, in particular water, from a fluid to be treated, in particular fuel, in particular diesel fuel, in particular of an internal combustion engine, in particular of a motor vehicle, which has at least one coalescence medium in the form of a hollow body for coalescing the at least one fluid medium to be separated.

Further, the invention relates to a separator device, in particular a filter, at least for separating at least one fluid medium to be separated, in particular water, from a fluid to be treated, in particular fuel, in particular diesel fuel, in particular of an internal combustion engine, in particular of a motor vehicle, having a housing which has at least one fluid inlet for the fluid to be treated, at least one fluid outlet for treated fluid, and at least one medium outlet for fluid medium separated from the fluid, and having at least one coalescence medium in the form of a hollow body, which is arranged in the housing in the flow path of the fluid to be treated, for separating the fluid medium, which is to be separated and is contained in the fluid.

### BACKGROUND

A fuel filter for fuel, in particular diesel fuel, of an internal combustion engine, in particular of a motor vehicle, and a filter element of such are disclosed in DE 10 2011 120 647 A1. A housing has at least one fuel inlet for fuel to be cleaned, at least one fuel outlet for cleaned fuel, and at least one water inlet for water separated from the fuel. The filter element, which segregates the fuel inlet from the fuel outlet in a leak-tight manner, is arranged in the housing. The filter element has a filter medium in the form of a hollow body, through which fluid can flow from the inside to the outside or from the outside to the inside in order to filter the fuel. The filter element has a coalescence medium in the form of a hollow body for separating water contained in the fuel. The coalescence medium is arranged in the flow path of the fuel after the filter medium, encompassing said filter medium or in the interior space bordered thereby.

### SUMMARY OF THE INVENTION

The invention is based on the object of designing a separator element and a separator device of the kind mentioned in the introduction with which the separation of fluid medium contained in the fluid to be treated is improved.

According to the invention, this object is achieved in that at least one pre-treatment medium for pre-treating the fluid to be treated is arranged in the flow path of the fluid to be treated before the at least one coalescence medium, encompassing said coalescence medium or in an interior space encompassed thereby.

According to the invention, the at least one pre-treatment medium is arranged upstream of the at least one coalescence medium. With the at least one pre-treatment medium, the state and or/properties of the fluid to be treated and/or of the fluid medium to be separated can be affected at least with regard to the separation. This enables a separation of the fluid medium to be separated to be improved. Further, with the at least one pre-treatment medium, a flow of the fluid to be treated can be improved, in particular homogenized. This enables the separation and, if applicable, a filtration to be improved.

Furthermore, the at least one pre-treatment medium can be used to pre-adsorb any additives contained in the fluid to be treated. The additives can be “filtered out” so to speak by means of the at least one pre-treatment medium. This enables downstream treatment media, in particular the at least one coalescence medium and/or any filter media and/or any segregating media, to be protected against additives. This prevents the downstream treatment media being affected, in particular impaired, in their respective functions by the additives. The additives can, in particular, be surface-active materials or substances. Appropriate additives are used, particularly with fuels, to change, in particular improve, their properties.

Advantageously, the separator element can have additional filtration properties. The separator element can also be designed as a filter element for filtering the fluid to be treated and be referred to as such.

Advantageously, the at least one coalescence medium can comprise at least one layer with a coalescence material which is suitable for coalescing the at least one fluid medium to be separated. The at least one coalescence medium can also comprise more than one layer of coalescence material. Different layers with different materials can also be provided. The at least one coalescence medium can also have other than a layer-type or coating-type structure.

With the at least one coalescence medium, the smallest droplets of the fluid medium to be separated, which are contained in the fluid to be treated, can also be combined to form larger drops. In doing so, the fine media droplets in the coalescence material can be held back and increased in size until they are carried along with the fluid flow once more and are discharged from the at least one coalescence medium. The at least one coalescence medium can consist of a single-layered or multi-layered stage which constitutes a bellows in pleated or wrapped form.

Advantageously, the at least one coalescence medium can comprise at least one layer with a fiber coalescence material which is suitable for coalescing the at least one fluid medium to be separated, in particular a fleece which is suitable for coalescing the at least one fluid medium to be separated.

A supporting body can be arranged downstream of the at least one coalescence medium, in particular of the separator element. Advantageously, a wall of the supporting body can be permeable to the fluid to be treated and/or the medium to be separated.

At least one segregating device, in particular at least one segregating medium, can be provided downstream of the at least one pre-treatment medium, preferably downstream of the at least one coalescence medium, for the actual separation of the fluid medium.

Advantageously, the separator element can be arranged in a housing of the separator device, in particular of a filter, such that it can segregate a fluid inlet of the housing from a fluid outlet in a leak-tight manner.

The invention is not restricted to a separator element of an internal combustion engine of a motor vehicle. Rather, it can also be used with other kinds of internal combustion engine, in particular industrial engines.

The separator element can be used for separating water from diesel fuel, and if applicable also for cleaning the diesel fuel. The separator element can also be used for cleaning/separating with other kinds of liquid fluid instead of diesel fuel.

In an advantageous embodiment, the at least one treatment medium can have an open-pored structure. Even the smallest water droplets can be successfully trapped in the open pore structure and combined to form larger water drops. In addition, this enables any risk of the at least one pre-treatment medium becoming clogged or blocked by any particles, in particular dirt particles, which may be contained in the fluid to be treated, to be reduced. This enables a filter medium for filtering out the particles upstream of the at least one pre-treatment medium to be dispensed with.

In a further advantageous embodiment, the at least one pre-treatment medium can be closed circumferentially, in particular wrapped.

Advantageously, at least one wrapping layer with/made of at least one pre-treatment medium can be provided. The number and/or thickness of the wrapping layer(s) can advantageously be specified according to requirements. This enables the installation space required to be better utilized than is the case with an in particular star-folded bellows, in particular filter bellows, alone.

In this context, “circumferentially” can refer to an element axis and/or a filter axis. Advantageously, the at least one coalescence medium can circumferentially encompass the element axis and/or filter axis.

In a further advantageous embodiment, the at least one pre-treatment medium can have at least one coalescence material which is suitable for coalescing the fluid medium to be separated or consist of at least one such material.

This enables the suspension formed from the fluid to be treated and the fluid medium to be separated to be preconditioned. Advantageously, the preconditioning can effect an enlargement of droplets/drops of fluid medium to be separated. A kind of “pre-coalescence” can be achieved with the at least one pre-treatment medium. The at least one pre-treatment medium can then be referred to as pre-coalescence medium.

The enlargement of the drops can lead to a better separability when segregating the fluid medium to be separated from the fluid to be treated during the further treatment of the fluid, in particular in a further stage of the separator element and/or of the separator device. This enables the drop sizes of the fluid medium to be separated to be significantly enlarged before entering the at least one coalescence medium and/or an actual separator stage in which the fluid medium to be separated is separated from the fluid.

The enlarged drops of the fluid medium can be further coalesced and enlarged in the at least one coalescence medium. This enables the separation to be simplified and/or improved. Consequently, higher separation grades can be achieved. This can be an advantage, particularly in the separation of water from fuel, in particular diesel fuel.

In a further advantageous embodiment, the at least one pre-treatment medium can have suitable filtration properties for filtering any particles, in particular dirt particles, contained in the fluid to be treated. A particle filtration capacity can be additionally achieved with the separator element in this way.

Advantageously, apertures, in particular pores or pore openings, of the at least one pre-treatment medium can be at least as large as corresponding apertures, in particular pores or pore openings of a downstream treatment medium, in particular of the at least one coalescence medium and/or, if applicable, the at least one filter medium and/or, if applicable, the at least one segregating medium. In this way, any larger particles can be filtered out by means of the at least one pre-treatment medium before they reach the following treatment media. This enables at least some of the particles to be prevented from contaminating and/or blocking the downstream treatment stages, in particular treatment media. This enables the downstream treatment media to be protected against particle loading. This enables a separation degree for the fluid medium to be separated to be better maintained and/or improved over the period of a defined contamination loading. Further, the service lives of the subsequent treatment media and/or the whole separator element can be increased.

In a further advantageous embodiment, the separator element can have at least one filter medium in the form of a hollow body, through which fluid to be treated can flow from the inside to the outside or from the outside to the inside in order to filter said fluid.

In particular, particles which contaminate the fluid to be treated can be filtered out by means of the filter medium.

Advantageously, the at least one filter medium can be single-layered or multi-layered. A filter medium which does not have a coating-type or layer-type structure can also be used.

Advantageously, the at least one filter medium can be folded and/or bent.

Advantageously, the at least one pre-treatment medium can be arranged in the flow path of the fluid to be treated before the at least one filter medium, encompassing said filter medium or in the interior space bordered thereby.

Advantageously, the at least one coalescence medium can be arranged in the flow path of the fluid to be treated after the at least one filter medium, encompassing said filter medium or in the interior space bordered thereby.

In a further advantageous embodiment, the at least one filter medium can be folded or bent particularly in the shape of a star. Appropriate folding enables the ratio of the active filtering surface area of the filter medium to the required installation space to be improved.

Instead of being folded in the shape of a star and/or in a zigzag shape, the filter medium can also be realized as a different kind of hollow body, in particular also unfolded.

In a further advantageous embodiment, the at least one pre-treatment medium can rest directly against a side, in particular the pre-filtration fluid side, of the in particular folded filter medium, or be at a distance therefrom; in particular, the filter medium can be wrapped with the at least one pre-treatment medium or vice versa. In this way, the at least one pre-treatment medium and the at least one filter medium can be arranged in a space-saving manner.

Advantageously, the at least one pre-treatment medium and/or the at least one coalescence medium can rest directly against a circumferential side of the in particular folded at least one filter medium. In particular, the at least one filter medium can be wrapped with the at least one pre-treatment medium and/or the at least one coalescence medium or vice versa.

The at least one pre-treatment medium and/or the at least one coalescence medium can rest directly, that is to say without a space, against the at least one filter medium. A supporting body for supporting the at least one pre-treatment medium and/or the at least one coalescence medium is therefore unnecessary, which reduces the number of components and the assembly effort. In this way, pre-treatment media and/or coalescence media, which alone have insufficient form stability, can also be used. The at least one filter medium can therefore afford stability and shape to the at least one pre-treatment medium and/or to the at least one coalescence medium. Further, this enables production to be simplified in that, in the case of at least one filter medium through which fluid flows radially from the inside to the outside, the at least one pre-treatment medium and/or the at least one coalescence medium can be wrapped around the previously produced at least one filter medium.

In addition or alternatively, the at least one pre-treatment medium and/or the at least one coalescence medium can be at a distance from the correspondingly facing circumferential side of the at least one filter medium.

In a further advantageous embodiment, the at least one pre-treatment medium and/or, if appropriate, the filter medium and/or the at least one coalescence medium can be arranged coaxially, in particular with respect to an element axis of the separator element and/or an axis, in particular filter axis, of the separator device.

A coaxial arrangement saves space. Further, in a coaxial arrangement, a flow of fluid to be treated radially from the outside to the inside or radially from the inside to the outside can easily be optimized. At the same time, the base surfaces of the at least one pre-treatment medium, the at least one coalescence medium, if appropriate the at least one filter medium and, if appropriate, the at least one segregating medium can be similar. However, the base surfaces can also be different. In particular, they can be round, oval or angular. Advantageously, the separator element/filter element can be or have a round filter element. Round filter elements can be designed in a particularly space-saving manner. Round filter elements enable an optimum ratio of filter/separator surface area to installation space to be realized.

The at least one pre-treatment medium, the at least one coalescence medium, if appropriate the at least one filter medium and/or, if appropriate, the at least one segregating medium can also be arranged other than coaxially with respect to one another or with respect to the element axis and/or with respect to the axis of the separator device.

Advantageously, the separator element can be multi-stage. The at least one pre-treatment medium can be arranged first viewed in the direction of flow. The at least one filter medium can be arranged downstream thereof. The at least one coalescence medium can be positioned thereafter. The upstream filter medium protects the coalescence medium against contamination. At least one coalescence medium can be arranged upstream of at least one filter medium.

The drops of the fluid medium to be separated can be precipitated downstream of the coalescence medium, in particular in a precipitation slot. Advantageously, the precipitation slot can be bounded on the side opposite the coalescence medium by the at least one segregating medium. The at least one segregating medium can have at least one material which acts in a repellent manner on the fluid medium to be separated. The medium drops can be segregated from the fluid to be treated by means of the at least one segregating medium. The drops of fluid medium to be separated can sink downwards due to their specific weight.

Fluids, in particular fuels, the specific weight of which is greater than that of the fluid medium to be separated, in particular water, with which, in a similar manner, the drops of fluid medium rise spatially, can also be treated, in particular cleaned, with the separator device according to the invention. For this purpose, the separator element can be arranged facing the opposite direction. Correspondingly, appropriate inlets and outlets of the housing can expediently be arranged differently.

Advantageously, the fluid medium to be separated can be collected, in particular in a collection chamber which can be connected to an outlet for the separated fluid medium.

The at least one segregating medium can be arranged in the interior of the at least one pre-treatment medium and/or the at least one coalescence medium and/or, if appropriate, the at least one filter medium. Instead of in the interior, the at least one segregating medium can also be arranged radially outwards encompassing the at least one pre-treatment medium, the at least one coalescence medium and/or, if appropriate, the at least one filter medium. The fluid to be treated can then flow radially through the appropriate treatment media from the inside to the outside.

If it is advantageously provided that fluid flows radially through the at least one pre-treatment medium from the outside to the inside, the at least one coalescence medium and, if appropriate, the at least one filter medium can preferably be located in the interior of the at least one pre-treatment medium. If, alternatively, it is provided that fluid flows radially through the at least one pre-treatment medium from the inside to the outside, the at least one coalescence medium and, if appropriate, the at least one filter medium can preferably be located outside and encompass the at least one pre-treatment medium.

The at least one pre-treatment medium, the at least one coalescence medium, if appropriate the at least one filter medium and/or, if appropriate, the at least one segregating medium can be realized as hollow cylinders, but also in a different form, in particular as hollow cones or truncated cones. Instead of with round base surfaces, they can also be realized with different kinds, in particular oval or angular, base surfaces.

According to the invention, the object is further achieved by the separator device in that at least one pre-treatment medium for pre-treating the fluid to be treated is arranged in the flow path of the fluid to be treated before the at least one coalescence medium, encompassing said coalescence medium or in an interior space encompassed thereby.

The advantages and characteristics highlighted in conjunction with the separator element according to the invention and its advantageous embodiments apply in a corresponding manner to the separator device according to the invention and its advantageous embodiments and vice versa.

Advantageously, the housing can be opened. The separator element can advantageously be replaceably arranged in the housing. The separator element can therefore be easily removed from the housing for replacement or for maintenance purposes. Instead of the replaceable separator element, an appropriate separator element, particularly one which is fixed in the housing, can also be provided.

### BRIEF DESCRIPTION OF THE DRAWINGS

Further advantages, features and details of the invention can be seen from the following description in which an exemplary embodiment of the invention is described in more detail with reference to the drawing. Expediently, the person skilled in the art will also consider the features disclosed in combination in the drawing, the description and the claims individually and combine them to form meaningful further combinations. In the single drawing,

FIG. 1 shows schematically a longitudinal section of a fuel filter with a replaceable, four-stage filter element which has a pre-coalescence medium.

Identical components in the figure are given the same references.

### DETAILED DESCRIPTION

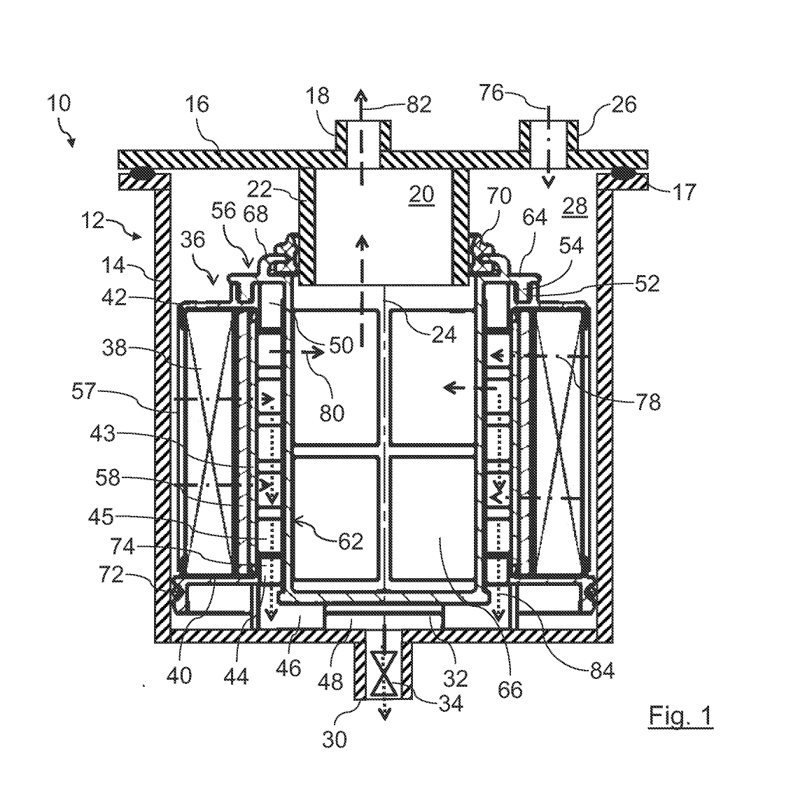

A fuel filter 10 of a fuel system of an internal combustion engine of a motor vehicle is shown in longitudinal section in FIG. 1. The fuel filter 10 serves to clean the fuel used for operating the internal combustion engine, for example diesel fuel. Further, the fuel filter 10 serves to separate water contained in the fuel. The fuel filter 10 can therefore also be referred to as a separator device for water or as a water separation device. The fuel can be treated/loaded with an additive which can affect the properties of the fuel in a manner which is of no further interest here.

The fuel filter 10 has a two-part housing 12 with a cup-shaped filter bowl 14 and a filter cover 16 which is removably arranged on the filter bowl 14. A sealing ring 17 is arranged between the filter bowl 14 and the filter cover 16.

An outlet union 18 for the cleaned fuel is arranged approximately centrally in the cover 16 and is connected outside the housing 12 to a fuel take-off line which is not shown in FIG. 1. In the interior of the housing 12, the outlet union 18 is connected to a discharge chamber 20 in an interior space of a connecting union 22. The connecting union 22 extends coaxially with respect to a filter axis 24 on the side of the cover 16 which faces the interior of the housing 12.

In the normal fitted position under normal operating conditions of the internal combustion engine, the filter axis 24 runs spatially vertically as shown in FIG. 1. In the following, “axial”, “radial”, “coaxial” and “circumferentially” refer to the filter axis 24 unless specified otherwise.

Radially outside the connecting union 22, the cover 16 has an inlet union 26 for the fuel to be cleaned which is connected to a feed chamber 28 in the housing 12. Outside the housing 12, the inlet union 26 is connected to a fuel feed pipe for the fuel, which is not shown in FIG. 1.

A water discharge union 30 is arranged coaxially with respect to the filter axis 24 in the base of the filter bowl 14. The water discharge union 30 is connected to a water collection chamber 32 at the bottom of the housing 12. Outside the housing 12, the water discharge union 30 is connected to a water drain pipe (not shown), by means of which water separated from the fuel can be discharged from the housing 12. A water drain valve 34 with a water level sensor is arranged in the water discharge union 30. In the quiescent state, the water drain valve 34 is closed so that no liquid can escape from the housing 12 from the water collection chamber 32 through the water discharge union 30. On reaching a specified maximum water level in the water collection chamber 32, the water drain valve 34 opens automatically, thus enabling the separated water to be drained via the water discharge union 30.

A replaceable filter element 36 is arranged in the housing 12. Because of its separator function for water from the fuel which is explained in more detail below, the filter element 36 can also be referred to as a “separator element” or a “water separator element”. The filter element 36 is designed as a round filter element. The filter element 36 segregates the inlet union 26 from the outlet union 18 in a leak-tight manner.

The filter element 36 comprises a star-shaped folded filter medium 38, with which in particular particles are filtered out of the fuel to be cleaned. Overall, the filter medium 38 has the form of a coaxial circular cylindrical sleeve. In the present exemplary embodiment, an element axis of the filter element 36 runs coaxially with respect to the filter axis 24. The filter medium 38 consists of one or more layers of a filter material.

The filter medium 38 is connected in a leak-tight manner to a terminating end disk 40 on a bottom face side facing the base of the filter bowl 14. At its top face side facing the cover 16, the filter medium 38 is connected in a leak-tight manner to a connecting end disk 42.

A skeleton-like, fluid-permeable central tube 43 extends coaxially in an interior space 45 of the filter medium 38 between the connecting end disk 42 and the terminating end disk 40 and connects the two end discs 40 and 42 stably to one another. The central tube 43 consists of axial ribs which are connected to one another by means of annular circumferential ribs.

The terminating end disk 40 has a coaxial opening 44. The opening 44 is encompassed by the central tube 43. The opening 44 connects the interior space 45 to the water collection chamber 32. On the outside facing the base of the filter bowl 14, the terminating end disk 40 has four supporting webs 46 which extend uniformly distributed along an imaginary coaxial circular cylindrical sleeve. The imaginary circular cylindrical sleeve encompasses the opening 44 and the water discharge union 30. The filter element 36 is supported against the base of the filter bowl 14 by means of the supporting webs 46. Located between the supporting webs 46 are connecting openings 48, by means of which water can also be distributed radially in the water collection chamber 32 outside the supporting webs 46.

The connecting end disk 42 has a coaxial opening 50. The opening 50 is encompassed by two coaxial projections which extend on the outside of the connecting end disk 42 in an axial direction. The two projections border an accommodating slot 52 for a ring-like insertion web 54 of a segregating unit 56 of the filter element 36.

The filter medium 38 is encompassed by a coaxial pre-coalescence medium 57 on its pre-filtration side. The pre-coalescence medium 57 is circumferentially closed and extends between the connecting end disk 42 and terminating end disk 40. The pre-coalescence medium 57 is at a distance radially from the radially outer circumferential side of the filter medium 38, that is to say the radially outer folded edges of the filter medium 38. The pre-coalescence medium 57 has the form of a coaxial hollow cylinder. The pre-coalescence medium 57 serves to combine even the smallest water droplets contained in the fuel to form larger water drops. The pre-coalescence medium 57 is wrapped around the filter medium 38. The pre-coalescence medium 57 has a coalescence material which is suitable for repelling water. The pre-coalescence medium 57 has an open-poured structure in which the smallest water droplets can be trapped and combined to form larger water drops. Further, the pre-coalescence median 57 additionally has filtration properties so that it can filter larger particles out of the fuel before they pass to the filter medium 38. A pore size of the pre-coalescence medium 57 is greater than corresponding pore sizes of the filter medium 38.

A coaxial coalescence medium 58 is located between the radially inner circumferential side of the filter medium 38 and the central tube 43, that is to say also within an interior space encompassed by the pre-coalescence medium 57. The coalescence medium 58 rests directly and without a space against the radially inner circumferential side of the filter medium 38. The coalescence medium 58 is circumferentially closed and extends between the connecting end disk 42 and terminating end disk 40. The coalescence medium 58 serves to combine even the smallest water droplets contained in the fuel, for example water droplets combined with the pre-coalescence medium 57, to form larger water drops.

The coalescence medium 58 comprises a coalescence material which is of no further interest here.

The segregation unit 56 has a supporting cage 62 with a connecting section 64 which also has the insertion web 58 and a segregating medium 66.

The connecting section 64 is approximately disk-shaped with a coaxial opening into which the connecting web 22 of the cover 16 projects. The connecting section 64 has a coaxial connecting web 68 on its outer side facing the cover 16. The connecting web 68 is bent radially inwards by 90 degrees at its free face side. A profile annular seal 70 sits on the radially inner edge of the connecting web 68. The connecting web 22 is inserted into the connecting web 68 such that the connection with the profile annular seal 70 is leak-tight.

The segregating unit 56 together with the segregating medium 66 is inserted in advance axially through the opening 50 of the connecting end disk 42. The supporting cage 62 and the segregating medium 66 are located in the interior space bordered by the coalescence medium 58, that is to say also in the interior space 45 of the filter medium 38.

The segregating medium 66 consists of a hydrophobic screen fabric. It has the form of a tube which is coaxial with respect to the filter axis 24. It extends from the connecting end disk 42 to the terminating end disk 40. The segregating medium 68 is circumferentially closed.

The circumferential wall of the supporting cage 62 is designed in the form of a mesh and is permeable to liquid. The supporting cage 62 is open on its face side facing the connecting union 22. The bottom face side of the supporting cage 62 facing the water collection chamber 32 is closed. The segregating medium 66 rests against the radially outer circumferential side of the supporting cage 62.

A precipitation slot 74 is located in the interior space 45 between the segregating medium 66 and the coalescence medium 58. The precipitation slot 74 has the form of an annular space. The precipitation slot 74 is bordered radially on the outside by the coalescence medium 58 and radially on the inside by the segregating medium 66.

Also arranged on the radially outer circumferential side of the termination end disk 40 is an annular seal 72 which is supported radially on the outside against the radially inner circumferential side of the filter bowl 14. The annular seal 72 seals the feed chamber 28 against the water collection chamber 32.

When the fuel filter 10 is in operation, fuel to be cleaned is fed from the fuel line indicated by an arrow 76 through the inlet union 26 to the feed chamber 28.

The fuel flows radially through the pre-coalescence medium 57 from the outside to the inside. Even the smallest water droplets contained in the fuel are trapped in the pre-coalescence medium 57 and combined to form larger water drops. Further, larger particles are filtered out of the fuel in the pre-coalescence medium 57. The pre-coalescence medium 57 forms a first stage of the overall four-stage fuel filter 10 for cleaning/water separation. When the drop size is sufficient, the large water drops are carried along by the flowing fuel once more.

The fuel with the enlarged water drop then flows through the filter medium 38, indicated by arrows 78, from its radially outer pre-filtered side to its radially inner clean side. In doing so, the fuel is freed from particles still contained therein. The filter medium 38 forms a second stage for cleaning/water separation.

On the clean side, the fuel which has been freed from particles flows radially through the coalescence medium 58 from the outside to the inside. In the coalescence medium 58, the water droplets contained in the fuel, that is to say also the water droplets combined with the pre-coalescence medium 58, are trapped and combined to form larger water drops. The coalescence medium 58 forms a third stage for cleaning/water separation. When the drop size is sufficient, the large water drops are carried along by the flowing fuel once more.

The fuel and the large water drops flow through the openings between the ribs of the central tube 43 and pass into the precipitation slot 74.

The fuel flows radially through the segregating medium 66, which forms a fourth stage for cleaning/water separation, from the outside to the inside, indicated by arrow 80, and passes upwards into the discharge chamber 20. The fuel which has been cleaned and freed from water leaves the discharge chamber 20 via the outlet union 18, indicated by arrows 82, and is fed to the fuel take-off line.

The large water drops on the other hand are held back by the segregating medium 66. In the precipitation slot 74, they sink due to their greater specific weight compared with the fuel, indicated by the arrow 84, into the water collection chamber 32.

As soon as the water level sensor of the water drain valve 34 detects that the specified maximum water level has been reached, the water drain valve 34 is automatically opened. The water leaves the water collection chamber 32 through the water discharge union 30 and passes into the water discharge pipe.

For maintenance purposes, for example to replace or to clean the filter element 36, the cover 16 is removed from the filter bowl 14 in the axial direction. The filter element 36 is then withdrawn from the filter bowl 14 in the axial direction.

To install, the filter element 36 is inserted into the filter bowl 14 in the axial direction with the termination end disk 40 first. The cover 16 is then placed onto the open side of the filter bowl 14 in the axial direction with the connecting union 22 first so that the connecting union 22 projects into the profile annular seal 70 in a leak-tight manner.

What is claimed is:

1. A separator element of a separator device of a filter for separating at least one fluid medium to be separated from a fuel of an internal combustion engine, comprising:
a hollow tubular body of at least one coalescence medium, the coalescence medium operative to separate the at least one fluid medium to be separated from the fuel ;
wherein the separator element has an element axis;
at least one pre-treatment medium arranged in the flow path of the fluid to be treated upstream of the at least one coalescence medium, the at least one pre-treatment medium encompassing or in an interior space encompassed thereby.

2. The separator element as claimed in claim 1, wherein
the at least one pre-treatment medium has an open-pored structure.

3. The separator element as claimed in claim 1, wherein
the at least one pre-treatment medium is circumferentially closed on its radial periphery.

4. The separator element as claimed in claim 1, wherein
the at least one pre-treatment medium has at least one coalescence material which is suitable for coalescing the fluid medium to be separated or consists of at least one such material.

5. The separator element as claimed in claim 1, wherein
the at least one pre-treatment medium has suitable filtration properties operative to filter out contaminating particles from the fluid to be treated.

6. The separator element as claimed in claim 1, wherein
the separator element includes at least one filter medium arranged as a hollow body and elongated on a filter axis;
wherein fluid to be treated flows radially outwardly through the at least one filter medium from a radial interior side of the at least one filter medium to a radial exterior side of the at least one filter medium, or flows radially inwardly through the at least one filter medium from a radial exterior side of the at least one filter medium to a radial interior side of the at least one filter medium.

7. The separator element as claimed in claim 6, wherein
the at least one filter medium is arranged as a folded filter medium, the folded filter medium having a star shape.

8. The separator element as claimed in claim 6, wherein
the at least one pre-treatment medium rests directly against and contacts the pre-filtered fluid side of the folded filter medium or
the at least one pre-treatment medium is arranged at a distance from the pre-filtered fluid side of the folded filter medium and is circumferentially wrapped with the at least one pre-treatment medium or vice versa.

9. The separator element as claimed in claim 6, wherein
the at least one pre-treatment medium and/or the filter medium and/or the at least one coalescence medium is arranged coaxially with respect to the element axis of the separator element and/or an axis of the filter of the separator device.

10. A separator filter device for separating at least one fluid medium to be separated from a fuel of an internal combustion engine, comprising:
a housing including
at least one fluid inlet for the fluid to be treated;
at least one fluid outlet to discharge the treated fluid; and
at least one medium outlet to discharge the fluid medium separated from the fluid;
a hollow tubular body of at least one coalescence medium, the coalescence medium operative to separate the at least one fluid medium to be separated from the fuel;
at least one pre-treatment medium arranged in the flow path of the fluid to be treated upstream of the at least one coalescence medium, the at least one pre-treatment medium encompassing or in an interior space encompassed thereby.
